(19) United States
(12) Patent Application Publication
(10) Pub. No.: US 2016/0262001 A1
(43) Pub. Date: Sep. 8, 2016

(54) METHOD FOR MANAGING RESOURCE UTILIZATION FOR MULTI-HOP DEVICE DISCOVERY AND DEVICE TO DEVICE COMMUNICATION

(71) Applicant: Samsung Electronics Co., Ltd., Gyeonggi-do (KR)

(72) Inventors: Ashish Kumar GUPTA, Bangalore (IN); Balaji Srinivasan THIRUVENKATACHARI, Bangalore (IN); Sivashankar SEKAR, Bangalore (IN)

(73) Assignee: Samsung Electronics Co., Ltd.

(21) Appl. No.: 14/796,600

(22) Filed: Jul. 10, 2015

(30) Foreign Application Priority Data
Mar. 3, 2015 (IN) 3725/CHE/2014

(51) Int. Cl. H04W 8/00; H04W 72/04; H04W 72/14; H04W 76/02; H04L 12/707

(52) U.S. Cl. CPC H04W 8/005; H04W 76/023; H04L 45/24; H04W 72/14; H04W 72/0493

(57) ABSTRACT

Apparatuses (including, but not limited to, user equipment (UE) and base stations, such as evolved Node Bs (eNBs)), systems, and methods for managing resource allocation and utilization for multi-hop device to device (D2D) communication are described. In one method, a UE sends a request to a network for a resource by which the UE can perform initial device discovery in order to perform D2D communication. If available, the network grants the resource and the UE performs initial device discovery using the resource, which includes calculating communication metrics. The UE then sends information based on the initial device discovery to the network which, based at least on that information and if available, sends back a grant for a resource for device discovery. The UE uses the grant to perform device discovery, which includes re-calculating the communication metrics.

### PRIORITY

This application claims priority under 35 U.S.C. §119(a) to an Indian Complete Patent Application filed in the Indian Intellectual Property Office on Mar. 3, 2015 and assigned Serial No. 3725/CHE/2014, and an Indian Provisional Patent Application filed in the Indian Intellectual Property Office on Jul. 30, 2014 and assigned Serial No. 3725/CHE/2014, the entire disclosures of both of which are incorporated herein by reference.

### BACKGROUND

1. Field of the Disclosure

The present disclosure relates generally to wireless communication and, more particularly, to a method for managing resource utilization for multi-hop device discovery and device to device communication.

2. Description of the Related Art

3GPP (3^{rd} Generation Partnership Project) Release 12 is the standardizing framework for Single Hop Device to Device (D2D) communication. The network provides resources for user equipment (UE) to perform device discovery and D2D communication. A network component, such as an evolved Node B (eNB), provides system information and a common pool of resources for sending discovery beacons. Additionally, the network provides a reserved set of resources for specific devices to perform device discovery and D2D communication.

D2D discovery and communication needs the existing radio resources used by networks for traditional network based UE communication. At present, the available D2D standards do not perform analysis to evaluate the best suited and/or resource efficient discovery and/or communication methods. Further, the current technologies do not have procedures which enable the UE (i.e., the Master D2D UE/device) to request required resources and/or provide information (metrics, such as matrix information) about the D2D cluster. The current technologies do not have procedures for the network to determine the optimal resources required for the master D2D UE/device to perform discovery and/or D2D communication by evaluating the metrics, such as the matrix information, of the D2D cluster. Additionally, there is no system which provides multi-hop device to device communication.

Therefore, there is need for apparatuses (including, but not limited to, UEs and base stations, such as eNBs), systems, and methods for managing and/or optimizing resource utilization for device discovery and device to device D2D communication, including multi-hop device discovery and D2D communication.

### SUMMARY

One aspect of the present disclosure provides apparatuses (including, but not limited to, UEs and base stations, such as eNBs), systems, and methods for effective resource utilization during device discovery and communication in D2D networks.

According to another aspect of the present disclosure, a UE performs D2D discovery by sending one or more requests for resources to the network and performing resource requirement estimation for the network.

According to yet another aspect of the present disclosure, a framework is provided for a network to indicate the resources available to the UE for performing D2D discovery and communication.

According to still yet another aspect of the present disclosure, a network controlled resource allocation scheme is provided, where D2D devices can receive information and/or indications concerning D2D discovery, D2D communication methods, D2D algorithms, and D2D resource allocation.

According to one aspect of the present disclosure, a method is provided for user equipment (UE) capable of device to device (D2D) communication, the method including sending a request, by a UE to a network, for a resource to perform initial device discovery for D2D communication; performing initial device discovery by the UE based on the resource granted by the network, the initial device discovery including calculating metrics related to device discovery; and performing device discovery by the UE based on the resource granted by the network, the device discovery including re-calculating metrics related to device discovery.

According to another aspect of the present disclosure, a method is provided for an evolved Node B (eNB) to support a user equipment (UE) capable of device to device (D2D) communication, the method including receiving a request, from a UE capable of D2D communication, for a resource to perform initial device discovery for D2D communication; transmitting a first grant of a resource, if available, for the UE to perform initial device discovery; receiving a response from the UE based on the initial device discovery, the initial device discovery by the UE including calculating metrics related to device discovery; and transmitting a second grant of a resource, if available, for the UE to perform device discovery based on the response from the UE, the device discovery by the UE including re-calculating metrics related to device discovery.

According to yet another aspect of the present disclosure, a user equipment (UE) capable of device to device (D2D) communication is provided, including a transceiver; and a controller configured to control the transceiver to send a request to a network for a resource to perform initial device discovery for D2D communication, perform initial device discovery based on the resource granted by the network, the initial device discovery including calculating metrics related to device discovery, and perform device discovery based on the resource granted by the network, the device discovery including re-calculating metrics related to device discovery.

According to still another aspect of the present disclosure, an evolved Node B (eNB) is provided, including a transceiver; and a controller configured to control the transceiver to receive a request from a user equipment (UE) capable of device to device (D2D) communication for a resource to perform initial device discovery for D2D communication; transmit a first grant of a resource, if available, for the UE to perform initial device discovery; receive a response from the UE based on the initial device discovery, the initial device discovery by the UE including calculating metrics related to device discovery; and transmit a second grant of a resource, if available, for the UE to perform device discovery based on the response from the UE, the device discovery by the UE including re-calculating metrics related to device discovery.

According to still yet another aspect of the present disclosure, a chip set is provided which is capable of supporting device to device (D2D) communication in a user equipment (UE) by executing a method according to which the UE performs the steps of sending a request, via a transceiver to a network, for a resource to perform initial device discovery for D2D communication; performing initial device discovery, via the transceiver, based on the resource granted by the network, the initial device discovery including calculating metrics related to device discovery; and performing device discovery, via the transceiver, by the UE based on the resource granted by the network, the device discovery including re-calculating metrics related to device discovery.

### BRIEF DESCRIPTION OF THE DRAWINGS

The above and other aspects, features and advantages of certain embodiments of the present disclosure will become more apparent from the following detailed description taken in conjunction with the accompanying drawings, in which:

FIG. 1 illustrates a wireless communication system;

FIG. 2 is a flow diagram of a UE-based method for managing resource utilization for device discovery for D2D communication, according to an embodiment of the present disclosure;

FIG. 3 is a flow chart of a UE-based method for managing resource utilization for device discovery for D2D communication, according to an embodiment of the present disclosure;

FIG. 4 is a flow diagram of a network-based method for managing resource utilization for device discovery for D2D communication, according to an embodiment of the present disclosure;

FIG. 5 is a flow chart of a network-based method for managing resource utilization for device discovery for D2D communication, according to an embodiment of the present disclosure;

FIG. 6 is a flow chart of a method for a UE to manage resource utilization and initiation of D2D communication, according to an embodiment of the present disclosure; and

FIG. 7 is a flow chart of a method for a network to manage resource utilization and initiation of D2D communication, according to an embodiment of the present disclosure.

### DETAILED DESCRIPTION OF EMBODIMENTS

Embodiments of the present disclosure will now be described in detail with reference to the accompanying drawings. However, the embodiments herein are only provided by way of example to more clearly explain the present disclosure. The present disclosure is not limited to these embodiments, and, as would be understood by one of ordinary skill in the art, the various details, components, and steps discussed in reference to the embodiments can be modified in various ways while still being in accordance with the present disclosure. In other words, many changes and modifications may be made within the scope of the disclosure herein without departing from the spirit thereof, and this disclosure includes all such modifications.

Although specific features of the present disclosure are shown in some drawings and not in others, this is done for convenience only as each feature may be combined with any or all of the other features in accordance with the present disclosure. In the accompanying drawings, like reference numerals may be used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined in other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. It will be understood that when an element is referred to as being “connected” or “coupled” or “attached” or “configured” to another element, it can be directly connected or coupled to the other element or intervening elements may be present. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Hereinafter the terms “device” and “user equipment (UE)” are used interchangeably.

Various embodiments of apparatuses (including, but not limited to, UEs and base stations, such as eNBs), systems, and methods for effective resource utilization during device discovery and communication in multi-hop D2D (device to device) networks are described herein.

In one embodiment, a user equipment (UE) performs resource requirement estimation and sends one or more requests for resources to the network for performing D2D discovery and communication. As defined in 3GPP Release 12 specifications (TS 36.300 and TS 36.331), which are incorporated herein by reference, the UE may obtain dedicated resources for performing communication and discovery from the network. Another embodiment provides a framework for the network to indicate the resources available to the UE for performing D2D discovery and communication. Yet another embodiment provides a method for network controlled resource allocation, including resource allocation for, and instructions to, D2D devices on the discovery and/or communication method(s)/algorithm(s). Depending on the context, the term UE and master UE may be used interchangeably. A ‘Master UE’ is defined as a UE initiating the D2D Discovery and Communication procedure, which may interact with the Network to obtain the resources to perform the D2D Discovery and Communication. Any UE which is D2D capable may become a master UE in a given topology.

In one embodiment, a framework is provided in which the master UE calculates resources dynamically (non-periodically or at a periodic interval) using calculated matrix information based on demand(s)/application requirement(s) for performing device discovery and/or communication with other UEs in a D2D multi-hop topology. Further, the master UE exchanges resource requirement(s) with the network and the network allocates best possible resources to the master UE. In some embodiments, the master UE is the UE who initiates device discovery and/or communication.

Some of the advantages of the embodiments of the present disclosure include, but are not limited to:
The present disclosure pertains to Multi-Hop D2D cluster communication, whereas the 3GPP Release 12 standardization concerns single hop D2D communication. To be precise, the current 3GPP release 12 specifications (as in TS 36.300, TS 36.331 and TS 23.303) define a framework in which the UE may perform Discovery and Communication within a geographical proximity. The present disclosure pertains to a multi hop environment wherein a UE may be able through an intermediate UE to transmit its Discovery beacons as well as route the Communication packets to D2D UEs well outside the current 3GPP Rel12 proximity constraints. Also the master UE herein defined in the present disclosure may be able to calculate the optimal resource utilization needs of the intermediate D2D UEs so as to enable the multi Hop framework.
The present disclosure provides, inter alia, resource-efficient device discovery and communication procedures, which, in turn, improve the network efficiency and user Quality of Service (QoS).
An embodiment of the present disclosure provides a UE-based framework—which helps the master UE clearly indicate/request only the resources required/best suited for its D2D application.
An embodiment of the present disclosure provides a network-based framework—in which the network is helped by UE-provided metrics to clearly understand the current D2D cluster environment, and provide sufficient resources to the UE.

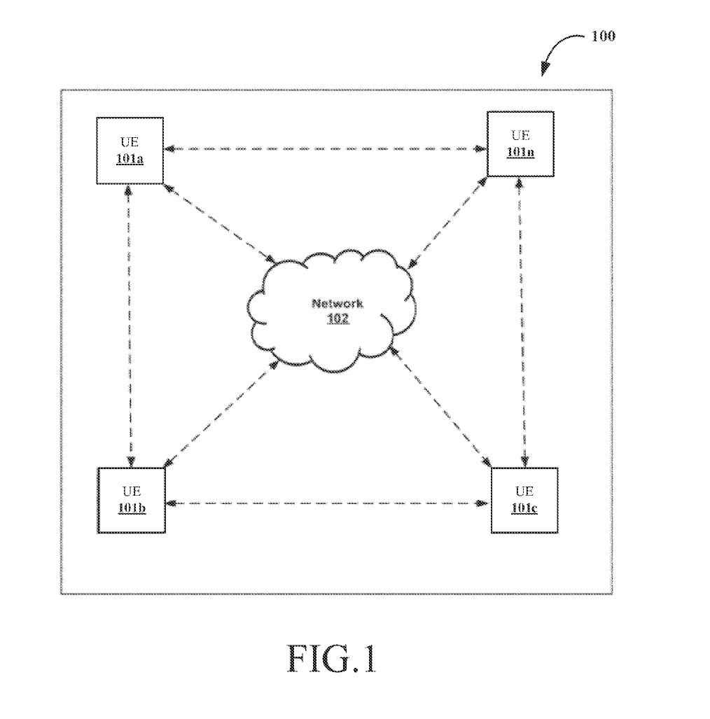

FIG. 1 illustrates a wireless communication system. The wireless communication system 100 comprises one or more user equipments (UEs) 101a, 101b, 101c, . . . , 101n and a network 102.

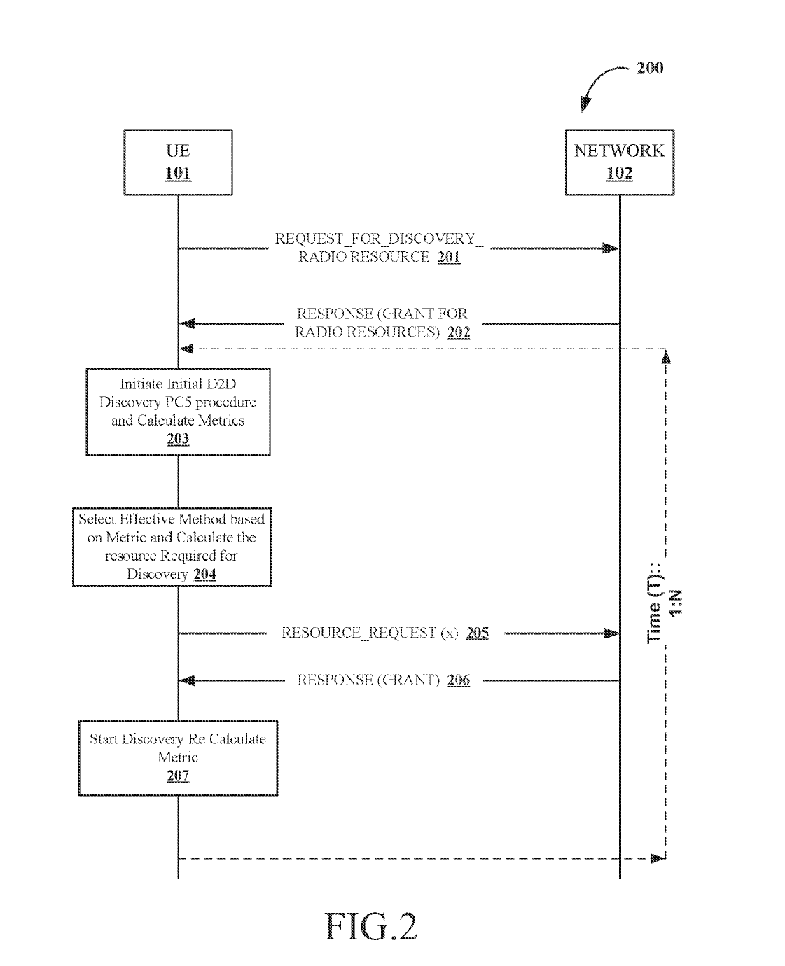

FIG. 2 is a flow diagram 200 of a UE-based method for managing resource utilization for device discovery for multi-hop device to device (D2D) communication, according to an embodiment of the present disclosure. At step 201, the UE, such as UE 101 in FIG. 1, sends a request to a network, such as network 102 in FIG. 1, for a resource to perform device discovery. At step 202, the network on receiving the request grants the resource (if available) to the UE. On receiving the grant of the resource, the UE initiates an initial device discovery procedure at step 203 and calculates metrics, including matrix information (some examples of which are discussed further below). At step 204, the UE selects an optimum method for device discovery based on the metrics/matrix information and calculates the resource(s) required for performing the device discovery procedure, using the selected optimum method.

At step 205, the UE sends a request for the resource determined in step 204 to the network. On receiving the request, the network provides a grant of the resource (if available) to the UE at step 206. At step 207, the UE starts the device discovery procedure on receiving the grant of the resource from the network. As per the embodiment of the present disclosure, as compared to the radio resource allocation in step 202, the radio resource request in step 205 is optimized based on the multi hop computation by the master UE, thereby ensuring optimal resource utilization when the network provides the required radio resources in step 206 for the UE. Steps 204-207 are performed every period of time T. Thus, time T is the time interval between two successive scans. After N scans (i.e. N*T time), a complete set of scans is performed.

In one embodiment, the matrix information included in the calculated metrics comprises a neighbor weight matrix and a route cost matrix (Lₓ). The information in the neighbor weight matrix includes the number of neighbors newly detected by a D2D device during its discovery beacon transmission. From this information, a weighted matrix of N_{y} is derived which represents the number of D2D devices with y unique neighbors (N₀ defines the number of devices which have no neighbors).

The route cost matrix (Lₓ) information includes the number of neighbors that the master UE can reach with ‘x’ hops (L₁ defines number of D2D devices in 1 hop from the master UE, etc.).

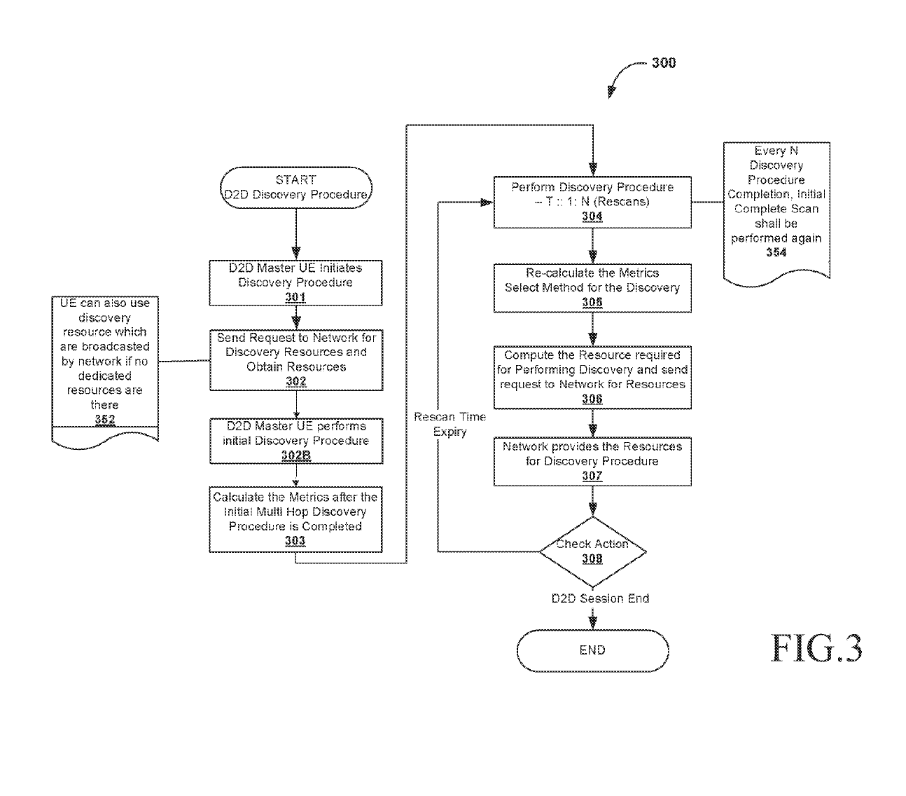

FIG. 3 is a flow chart of a UE-based method for managing resource utilization for device discovery for, e.g., multi-hop device to device communication, according to an embodiment of the present disclosure. At step 301, a master UE, such as UE 101 in FIG. 1, initiates a device discovery procedure. At step 302, the master UE sends a request for a resource to a network, such as network 102 in FIG. 1, and obtains the resource based on availability as determined by the network. As an alternative, in other embodiments, as shown by reference numeral 352 in FIG. 3, the UE uses a resource which is broadcasted by the network for the device discovery procedure if no dedicated resources are available. At step 303, the master UE calculates metrics, such as matrix information, once the initial multi-hop device discovery procedure is completed. Using the radio resources available for performing the D2D discovery, the master UE may perform the multi hop discovery procedure. This may be referred herein as the Initial discovery procedure, where the metrics calculated may be used for further optimization of the radio resources to be requested over the time to continue Direct Discovery and communication.

At step 304, the UE initiates the device discovery procedure. In one embodiment, a complete set of scans is performed on completion of N device discovery procedures/scans, i.e., steps 304-308, which are performed every time period T. At step 305, the metrics, including the matrix information, are re-calculated, and an optimum method for device discovery is selected based on the re-calculated metrics/matrix information. At step 306, the UE computes the resource(s) required for performing the device discovery procedure according to the optimum method determined in step 305, and then transmits a request for the resource to the network. In one embodiment, the master UE sends the request by a new uplink Radio Resource Control (RRC) message. The resource could also be requested through a new additional Information Element (IE) or an extension as part of the existing RRC uplink message or the existing Medium Access Control (MAC) uplink message. At step 307, the network provides the resources for the UE to perform the device discovery procedure (if they are available). At step 308, a check is performed to determine whether time T has expired since the last device discovery procedure/scan and whether the D2D session has ended. If time T has expired, steps 304-307 are performed again. If the D2D session ends, the device discovery procedure is stopped.

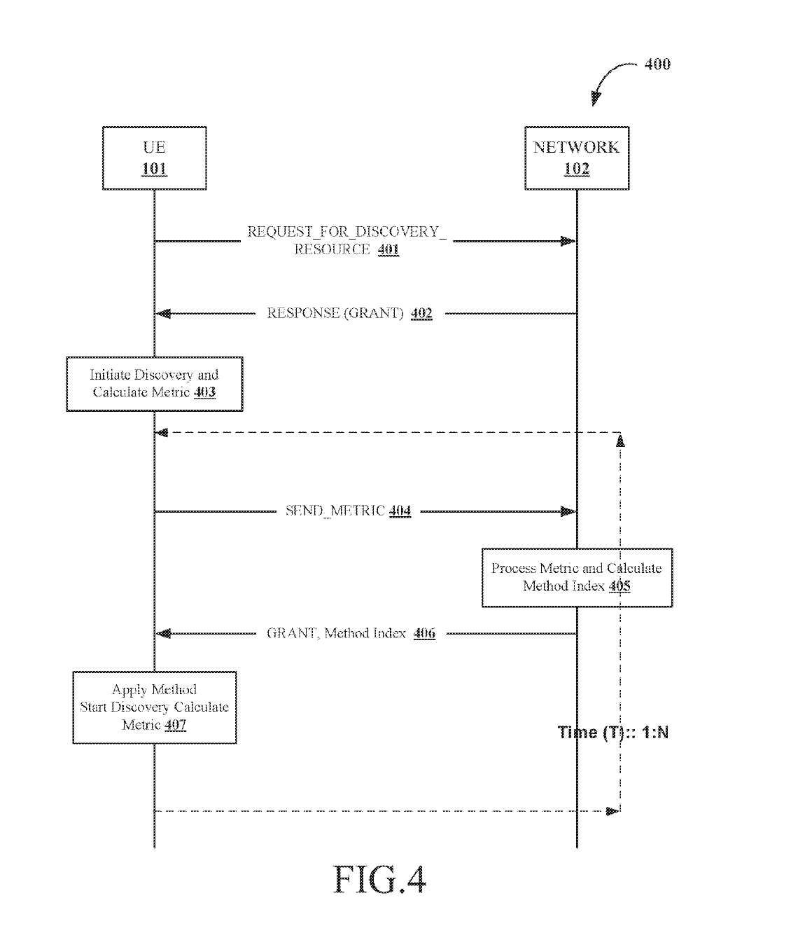

FIG. 4 is a flow diagram 400 of a network-based method for managing resource utilization for device discovery for multi-hop device to device communication, according to an embodiment of the present disclosure. At step 401, the UE, such as UE 101 in FIG. 1, sends a request to the network, such as network 102 in FIG. 1, for the resource to perform device discovery. At step 402, the network provides a response with a grant of the resource to the UE (if available). At step 403, the UE performs initial device discovery and then calculates the metrics, including matrix information. At step 404, the UE provides the calculated metrics, including the matrix information, to the network. Then at step 405, the network processes the received metrics, including the matrix information, and calculates a method index. The method index is a possible methodology that may be adopted for communication by the standard specifications. The method index may denote for instance representation for unicast or broadcast or any other communication methodology as defined. At step 406, the network provides a grant of a resource along with the method index to the UE. At step 407, the network 102 starts the device discovery procedure based on the resource and subsequently calculates method index. Steps 404-407 are performed every period of time T. Thus, time T is the time interval between two successive scans. After N scans (i.e. N*T time), a complete set of scans is performed.

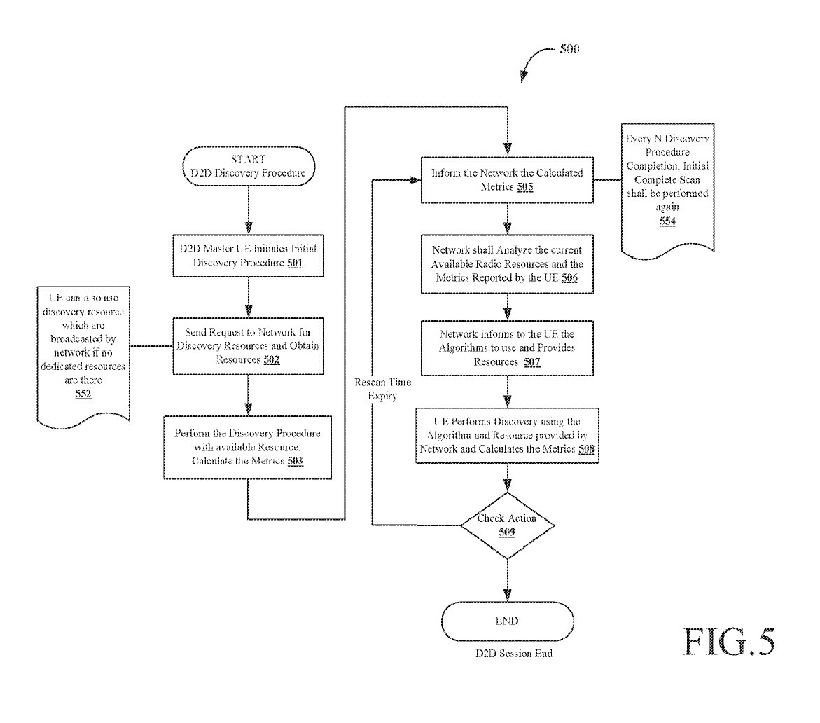

FIG. 5 s a flow chart of a network-based method for managing resource utilization for device discovery for, e.g., multi-hop device to device communication, according to an embodiment of the present disclosure. At step 501, the device discovery procedure is initiated by a master UE, which could be UE 101 in FIG. 1. At step 502, the master UE sends a request to a network, which could be network 102, for resource(s) to perform device discovery and obtains the grant of the resource(s), if available. As an alternative, in other embodiments, as shown by reference numeral 552 in FIG. 5, the UE uses a resource for device discovery which is broadcasted by the network if no dedicated resource is available. At step 503, the UE performs device discovery with the granted resource(s) and then calculates the metrics, including matrix information. At step 505, the network is informed/provided with the calculated metrics/matrix information by the UE. In one embodiment, the master UE sends the calculated metrics/matrix information to the network by a new uplink RRC message. In other embodiments, the metrics/matrix information is transmitted using a new additional Information Element (IE) or extension as part of the existing RRC downlink message or the existing MAC downlink message.

At step 506, the network analyzes the available radio resources and the metrics/matrix information received from the UE. Based on the analysis, the network selects and then, at step 507, provides an optimum method/algorithm for the UE to perform device discovery along with the grant(s) for the required radio resource(s). This may be transmitted to the UE by a new downlink RRC message. At step 508, the UE performs device discovery using the provided optimum method/algorithm and the granted radio resource(s), and recalculates the metrics/matrix information. At step 509, a check is performed to determine whether time T has expired since the last device discovery procedure/scan and whether the D2D session has ended. If time T has expired, the steps 505-508 are performed again. If the D2D session ends, the device discovery procedure is stopped. In one embodiment, device discovery stops after N scans have been performed.

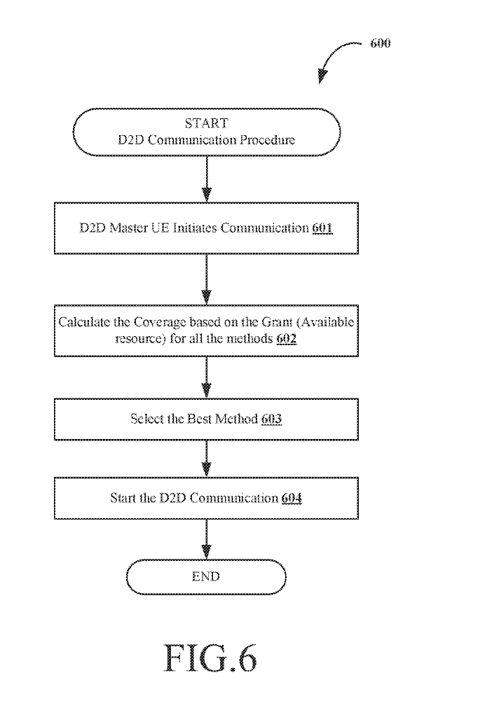

FIG. 6 is a flow chart of a method for a UE to manage resource utilization and initiation of multi-hop device to device communication, according to an embodiment of the present disclosure. At step 601, a master UE, such as UE 101 in FIG. 1, initiates the communication with other UEs in the network, such as network 102 in FIG. 1. Direct Communication enables two D2D UEs to directly communicate with each other using the provisioned radio resources without the data packets being routed through the network, as is the case in a traditional wireless communication scheme. At step 602, the master UE calculates the radio coverage based on a resource granted by the network. At step 603, the master UE selects an optimum method for D2D communication based on the resource granted by the network 102. At step 604, the master UE starts the D2D communication. Performing D2D communication comprises determining network coverage based on the granted resource and selecting an optimum method based on the granted resource by the UE.

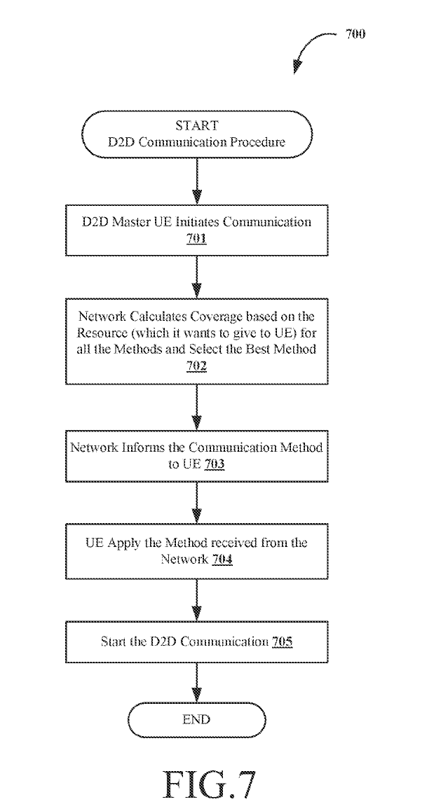

FIG. 7 is a flow chart of a method for a network to manage resource utilization and initiation of multi-hop device to device communication, according to an embodiment of the present disclosure. At step 701, a master UE, such as UE 101, initiates the communication with other UEs in a network, such as network 102. The Direct Communication phase may enable two D2D UEs to directly communicate with each other using the provisioned radio resources without the data packets being routed through the network, as in the case of a traditional wireless communication scheme. At step 702, the network calculates radio coverage for all the methods based on the resource the network intends to grant to the UE for performing communication, and selects a method for the UE to perform D2D communication based on the calculated radio resource coverage. At step 703, the network informs the UE of the method selected for the UE to perform D2D communication. At step 704, the UE 101 applies the selected method received from the network and then starts the D2D communication at step 705. A UE as defined in the standard specifications may initiate D2D communication when authorized and is interested to perform proximity services.

Following are device discovery procedures/methods (including D2D discovery procedures, methods, or algorithms) which can be used in accordance with the present disclosure:
All Node verification method, where all the devices in the cluster may send discovery beacon, but only newly available nodes may respond back with discovery response.
Hotspot Only Discovery method, where only the hotspot device(s) in the cluster transmits discovery beacon. Here “hotspot device” means any D2D device which has the maximum number of unique neighbors within the D2D cluster.
Leaf Only Discovery method, where only the leaf device(s) in the cluster may transmit discovery beacons. Here, “leaf device” or “edge device” means any D2D device which has the no unique neighbors within the D2D cluster.
Water-drop Discovery method, where discovery is performed by layer with a specific number of neighbors in successive time periods (Say n₁ in T, n₂ in 2T, etc.).
Incremental Discovery from Leaf method, where discovery is performed till layer containing specific number of neighbors in successive time intervals (Say Till n1 in T, Till n2 in 2T, etc.).
Incremental Discovery from Hotspot method, which differs from the above method only in that the layers may be considered from Hotspot devices (n_{Y}) instead of starting from leaf devices (n₀).
Water-drop Response method, where the discovery responses are periodically echoed back by layers at specific hop distances in each time interval (l₀ at T, l₁ hat 2T, etc.).
Incremental response from minimum hop method, where the discovery responses are echoed back by devices till a specific hop distance in successive time instances (Till l₁ at T, l₂ at 2T, etc.).
Incremental response from maximum distance method, which differs from the above method only in that the layers may be considered from maximum hop neighbor (lₓ) instead of the nearest neighbors (l₀).

Depending on the embodiment, some or all of the steps, operations, and/or functions described herein may be implemented or otherwise performed, at least in part, using one or more controllers and/or processors running instruction(s), program(s), interactive data structure(s), client and/or server components, where such instruction(s), program(s), interactive data structure(s), client and/or server components are stored in one or more non-transitory computer-readable media. The one or more non-transitory computer-readable media may be instantiated in software, firmware, hardware, and/or any combination thereof.

The one or more non-transitory computer-readable media and/or means for implementing/performing one or more operations/steps/modules of embodiments of the present innovation(s) may include, without limitation, application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of any system components and/or data structures may also be stored as contents (e.g., as executable or other non-transitory machine-readable software instructions or structured data) on a non-transitory computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of any system components and data structures may also be stored as data signals on a variety of non-transitory computer-readable transmission mediums, from which they are read and then transmitted, including across wireless-based and wired/cable-based mediums, and may take a variety of forms (e.g., as part of a single or multiplexed analog signal, or as multiple discrete digital packets or frames).

Thus, the term “non-transitory computer-readable medium” as used herein refers to any medium that comprises the actual performance of an operation (such as hardware circuits), that comprises programs and/or higher-level instructions to be provided to one or more processors for performance/implementation (such as instructions stored in a non-transitory memory), and/or that comprises machine-level instructions stored in, e.g., firmware or non-volatile memory. Non-transitory computer-readable media may take many forms, such as non-volatile and volatile media, including but not limited to, a floppy disk, flexible disk, hard disk, RAM, PROM, EPROM, FLASH-EPROM, EEPROM, any memory chip or cartridge, any magnetic tape, or any other magnetic medium from which a computer instruction can be read; a CD-ROM, DVD, or any other optical medium from which a computer instruction can be read, or any other non-transitory medium from which a computer instruction can be read.

Although specific embodiments of apparatuses (including, but not limited to, UEs and base stations, such as eNBs), systems, and methods have been described in connection with the accompanying drawings, the present disclosure is not limited thereto. It will be apparent to those of ordinary skill in the art that various substitutions, modifications and changes may be made thereto without departing from the scope and spirit of the disclosure, as defined by the following claims and their legal equivalents.

What is claimed is:

1. A method for user equipment (UE) capable of device to device (D2D) communication, the method comprising:
sending a request, by a UE to a network, for a resource to perform initial device discovery for D2D communication;
performing initial device discovery by the UE based on the resource granted by the network, the initial device discovery including calculating metrics related to device discovery; and
performing device discovery by the UE based on the resource granted by the network, the device discovery including re-calculating metrics related to device discovery.

2. The method of claim 1, wherein the UE is a master UE and the communication is multi-hop D2D communication.

3. The method of claim 1, wherein the calculated and/or re-calculated metrics include matrix information.

4. The method of claim 1, further comprising, after the initial device discovery:
selecting an optimum method by the UE for performing the device discovery; and
determining, by the UE, a resource required to perform the device discovery based on the selected optimum method.

5. The method of claim 4, further comprising:
sending, by the UE, a request to the network for the determined resource required to perform the device discovery based on the selected optimum method.

6. The method of claim 5, further comprising:
receiving, by the UE, a grant of a resource to perform the device discovery from the network,
wherein the grant includes resource required to perform the device discovery based on the selected optimum method.

7. The method of claim 6, wherein the UE repeats the steps of performing device discovery, including re-calculating metrics related to the device discovery; selecting an optimum method for performing the device discovery; determining a resource required to perform device discovery based on the selected optimum method; and sending a request to the network for the determined resource required to perform the device discovery based on the selected optimum method.

8. The method of claim 1, further comprising, after the initial device discovery:
transmitting the metrics to the network.

9. The method of claim 8, further comprising:
receiving, by the UE, a grant of a resource to perform the device discovery and a method index from the network,
wherein the UE performs the device discovery based on the method index.

10. The method of claim 9, wherein the UE repeats the steps of performing device discovery, including re-calculating metrics related to the device discovery based on the resource to perform the device discovery and method index; transmitting the metrics to the network; and receiving another grant for a resource and a method index for the UE to perform device discovery.

11. The method of claim 1, wherein the device discovery uses one or more resources broadcasted by the network.

12. The method of claim 1, further comprising:
determining network coverage based on the granted resource to the UE by the network, for the D2D communication;
selecting an optimum method based on the granted resource by UE, for performing the D2D communication; and
performing the D2D communication by the UE, based at least on the calculated metrics, the determined network coverage, and the selected optimum method.

13. A method for an evolved Node B (eNB) to support a user equipment (UE) capable of device to device (D2D) communication, the method comprising:
receiving a request, from a UE capable of D2D communication, for a resource to perform initial device discovery for D2D communication;
transmitting a first grant of a resource, if available, for the UE to perform initial device discovery;
receiving a response from the UE based on the initial device discovery, the initial device discovery by the UE including calculating metrics related to device discovery; and
transmitting a second grant of a resource, if available, for the UE to perform device discovery based on the response from the UE, the device discovery by the UE including re-calculating metrics related to device discovery.

14. The method of claim 13, wherein receiving the response from the UE comprises:
receiving a request for a resource the UE determined is required to perform the device discovery based on an optimum method selected by the UE,
wherein the second grant is for the resource the UE determined is required to perform the device discovery based on an optimum method selected by the UE.

15. The method of claim 13, wherein receiving the response from the UE comprises:
receiving metrics calculated by the UE based on the initial device discovery with the first granted resource.

16. The method of claim 15, further comprising:
determining, based on the received metrics, a method index and a resource for the UE to perform device discovery.

17. The method of claim 16, wherein the second grant is for the determined resource further comprising:
transmitting the method index,
wherein the UE performs device discovery based on the determined resource and the method index.

18. A user equipment (UE) capable of device to device (D2D) communication, comprising:
a transceiver; and
a controller configured to:
control the transceiver to send a request to a network for a resource to perform initial device discovery for D2D communication,
perform initial device discovery based on the resource granted by the network, the initial device discovery including calculating metrics related to device discovery, and
perform device discovery based on the resource granted by the network, the device discovery including re-calculating metrics related to device discovery.

19. An evolved Node B (eNB), comprising:
a transceiver; and
a controller configured to:
control the transceiver to receive a request from a user equipment (UE) capable of device to device (D2D) communication for a resource to perform initial device discovery for D2D communication;
transmit a first grant of a resource, if available, for the UE to perform initial device discovery;
receive a response from the UE based on the initial device discovery, the initial device discovery by the UE including calculating metrics related to device discovery; and
transmit a second grant of a resource, if available, for the UE to perform device discovery based on the response from the UE, the device discovery by the UE including re-calculating metrics related to device discovery.

20. A chip set capable of supporting device to device (D2D) communication in a user equipment (UE) by executing a method according to which the UE performs the steps of:
sending a request, via a transceiver to a network, for a resource to perform initial device discovery for D2D communication;
performing initial device discovery, via the transceiver, based on the resource granted by the network, the initial device discovery including calculating metrics related to device discovery; and
performing device discovery, via the transceiver, by the UE based on the resource granted by the network, the device discovery including re-calculating metrics related to device discovery.
